(19) United States
(12) Patent Application Publication
(10) Pub. No.: US 2007/0083434 A1
(43) Pub. Date: Apr. 12, 2007

(54) SYSTEM AND METHOD FOR BROKERING THE SALE OF ADVERTISING ON CONTAINERS

(76) Inventors: Jeanette Fenti, Webster, NY (US); Derek E. Messner, Fairport, NY (US)

Correspondence Address: BASCH & NICKERSON LLP, 1777 PENFIELD ROAD, PENFIELD, NY, 14526, US

(21) Appl. No.: 11/538,279

(22) Filed: Oct. 3, 2006

Related U.S. Application Data
(60) Provisional application No. 60/723,048, filed on Oct. 3, 2005.

(51) Int. Cl. G06Q 99/00; G07G 1/14; G06Q 30/00

(52) U.S. Cl. 705/14; 705/1

(57) ABSTRACT

A system and method for the automated brokering of advertising space on beverage or similar containers offered by retail distributors, and more particularly brokering of advertising space on retailer-branded products for related goods or services (e.g., milk jug container advertising for breakfast cereal or cookies).

This application claims priority from U.S. Provisional Patent Application No. 60/723,048, for a “System and Method for the Management of Advertising on Containers,” by J. Fenti et al., filed Oct. 3, 2005, which is hereby incorporated by reference in its entirety.

A system and method for providing portable advertisement originating at a retail outlet, including the automated brokering of advertising space on beverage containers offered by retail beverage distributors, and more particularly brokering of advertising space on retailer-branded products for related goods or services (e.g., milk jug advertising for breakfast cereal or cookies).

### BACKGROUND AND SUMMARY

A new avenue for advertising has been identified by several companies that arrange for the placement of advertisements on milk and similar beverage containers. However, one downfall of such advertising is that it fails to address the needs of privately branded products or to take advantage of cross-product advertising because there is little or no coordination between the advertising appearing on a container, for example a milk jug, and the presence of the advertised product in the same store. In other words, there is less advantage in advertising a particular brand of cookies on a milk container that is sold in a store that does not sell that brand of cookies. Hence, there is a need to coordinate the advertisement/marketing of related products.

Due to the current advertising process, milk advertisers that merely work to place advertisements on containers, also fail to provide any advantage or incentive for retailers (particularly those having their own branded products, such as milk) to place advertisements on the branded goods. In fact, the presence of other advertising may be viewed by some retailers as a detriment to their private brand. They fail to appreciate that the space on such containers could be leveraged by the private brand retailer for the sale of advertising. Moreover, no systems are in place to provide timely and accurate sales or brokering of such advertising space in a manner suitable to meet the turnaround time for perishable or dated beverages such as milk and the like.

In response, the system and method described herein are directed to a robust process that not only provides for the placement of targeted advertising on product containers such as milk jugs or cartons, particularly for branded products, but also for the management and tracking of such advertisement, reporting to advertisers and coordinating with the retailer to improve not only satisfaction with, but also revenue from, advertisement on beverage containers.

One aspect of the invention disclosed herein is directed to a method for managing the sale of advertising on beverage containers, comprising: receiving, from a retailer, beverage order data indicating a quantity of future beverage orders issued from said retailer to a bottler; in response to said beverage order data, determining available advertising space associated with the beverage order; automatically offering, to at least one advertiser, at least a portion of the available advertising space associated with the beverage order; automatically receiving, from the at least one advertiser, an acceptance of at least a portion of the available advertising space; in response to the acceptance, requesting advertising copy in a format suitable to fit within a predefined shape; upon receiving the advertising copy, preparing printed copy including the advertising ; affixing the printed copy to a plurality of beverage containers; and tracking, with said retailer, sales of the beverage containers bearing the printed copy in conjunction with sales of at least one product indicated in the printed copy so as to determine a correlation between the beverage container advertising and any change in product sales volumes.

Another aspect of the invention disclosed herein is directed to a distributed system for managing the sale of advertising on beverage containers, comprising: a retailer computer for automatically compiling, from a plurality of retail locations, orders for beverages being sold in containers, said containers having space for advertising thereon, and tracking the sales of such beverages; an advertising broker computer for receiving, from the retailer computer, beverage order data indicating a quantity of future beverage orders issued from said retailer, wherein in response to the beverage order data, the advertising broker computer (a) determines available advertising space associated with the beverage order, (b) automatically offers, to at least one advertiser, at least a portion of the available advertising space associated with the beverage order, (c) automatically receives, from an advertiser data indicating an acceptance for advertising offered on at least a portion of the available advertising space, and (d) in response to the advertiser's acceptance, places an order for advertising copy; the advertising broker computer also tracking, with said retailer, sales of beverage containers bearing printed advertising copy in conjunction with sales of at least one product indicated in the advertising copy to determine a correlation between the beverage container advertising and product sales volumes.

A further aspect of the disclosed invention is directed to a method for managing the sale of product advertising on containers, comprising: receiving, from a retailer, product order data indicating a quantity of future product orders issued from said retailer to a product supplier, said data identifying at least one characteristic of the container; in response to said product order data, determining available advertising space and quantity associated with the product order based upon the container characteristic; offering, to at least one advertiser, at least a portion of the advertising space and quantity available as a result of the product order; receiving, from the at least one advertiser, an acceptance of at least the portion of the available advertising space and quantity; and placing advertising copy in the portion of the advertising space and quantity available on product containers.

### BRIEF DESCRIPTION OF THE DRAWINGS

FIG. 1 is a general illustration of data flow and financial transactions occurring in accordance with one aspect of the present invention;

FIG. 2 illustrates an embodiment of the present invention;

FIGS. 3, 5A-5D, 6A-6D, 7A-7G and 8A-8F are illustrative examples of the placement of advertising and advertising locations on an exemplary beverage container;

FIGS. 4A-4I are examples of die cut shapes that may be employed for the printing of advertising as illustrated in FIGS. 3; and

FIG. 9 is a flowchart depicting a method for accomplishing aspects of the present invention.

### DETAILED DESCRIPTION

Although described herein relative to the placement of advertising on the side panels of a milk container, the present invention may also be directed to the placement of advertising on a plurality of related goods that are typically purchased by consumers, including many branded goods (breakfast cereals, canned goods, other dairy products and meat/deli products). In the case of several of the aforementioned products, current label-printing technology found in the retail locations (e.g., meat department) may be suitable for printing of labels bearing advertisements as disclosed and described below. Accordingly, the following disclosure is intended to be construed in a broad sense and not limited to the specific embodiments described.

It should be appreciated that aspects of the disclosed invention are particularly directed to the cost-effective sale or brokering of advertising space on portable consumer goods such as grocery products and the like. More particularly, the invention seeks to provide further opportunity in a low-margin, high-volume retail setting that will enable grocers to profitably “sell” space on their products for consumer-directed advertising.

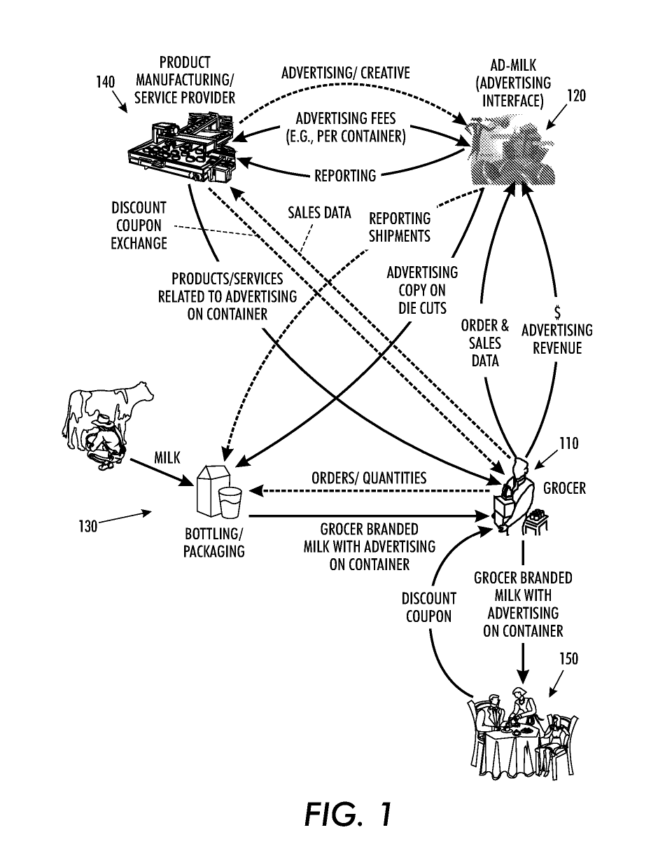

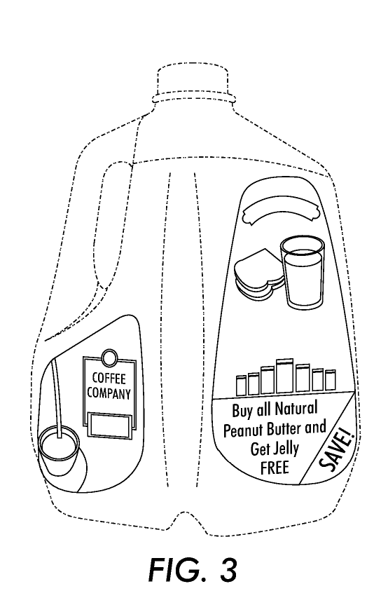

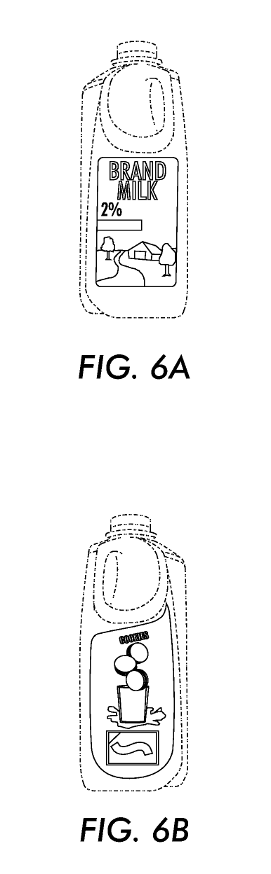

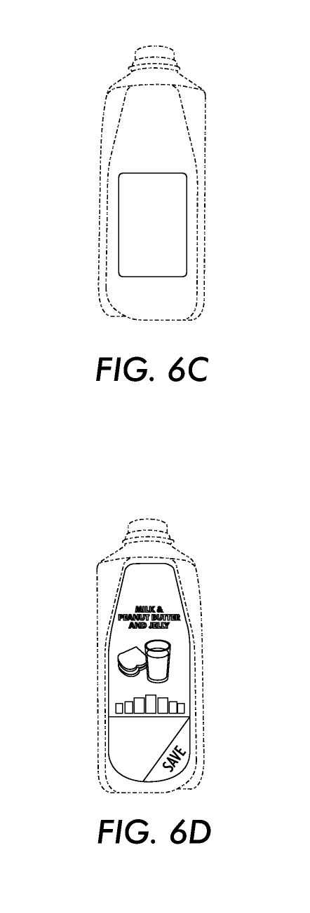

Turning to FIG. 1, there is depicted a data flow and representation of the financial transaction taking place in accordance with an embodiment of the present invention. In particular, the embodiment is related to the placement of advertising on one or more side panels of a retailer-branded milk jug as illustrated, for example in FIGS. 3, 5A-5D and 6A-6D.

FIG. 1 generally depicts the flow of data in a method for managing the sale of advertising on beverage containers such as milk jugs (plastic containers having a paper-based label on at least one side or surface thereof). As illustrated, the method includes locating a retailer 110 selling a branded beverage, said beverage being sold in containers having space for advertising thereon (see FIG. 3). The advertising interface 120 (Ad-Milk) receives, from the retailer, beverage order data indicating a quantity of future beverage orders issued from said retailer to a bottler. It will be appreciated that this data may take several forms, but preferably includes a time-based component, whereby the advertising interface would be able to process the data and to identify actual quantities ordered for particular days, weeks, months so as to determine the amount of advertising “space” available for sale.

In other words, in response to the beverage order data the advertiser interface 120 determines available advertising space associated with the beverage order; from the retailer. It is also possible that the order data, having been provided from the retailer 110 to the bottler 130, is provided to the advertising interface 120 via the bottler, or that the bottler may supplement the data to indicate anticipated production runs etc. that provide order quantity detail to the advertising interface.

One the available advertising space is determined by the advertising interface, the space is automatically offered to at least one advertiser. It will be appreciated that advertising space may be on a per-container or per panel (side or surface of container) basis. In other words, at least a portion of the available advertising space associated with the beverage order is made available to advertisers. Although not specifically illustrated, one of the functions contemplated for the advertising interface (e.g., broker), or more specifically a computer-based system operated on behalf of the advertising interface, is automatically offering available advertising space and automatically receiving an acceptance or order for advertising.

In addition, the computer operated by the advertising interface may conduct a bidding process (when there is greater demand that supply of advertising space) whereby an advertiser 140 selects or competitively bids on one or more of the following characteristics: advertising quantity, advertising panels per beverage container, advertising exclusivity (single advertiser controls all panels on a beverage container), or regional exclusivity (advertiser has exclusivity for all beverage containers in a region for a particular time period). As will be apparent to those familiar with a competitive bidding process, the process adjusts the acceptable bidding price per unit (beverage container) as a function of at least one of the characteristics.

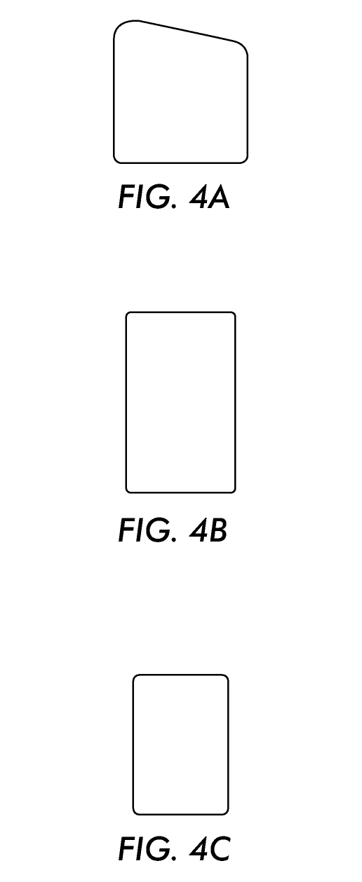

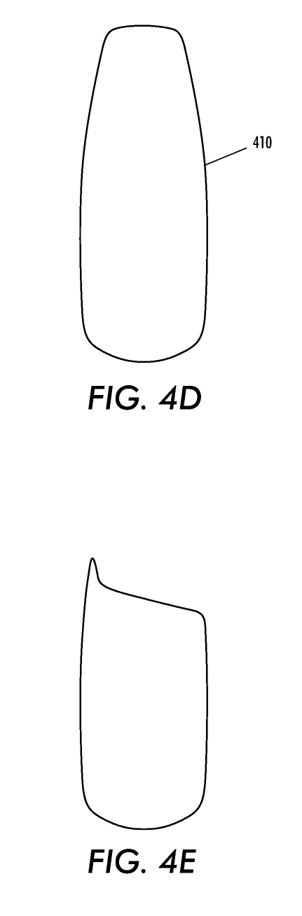

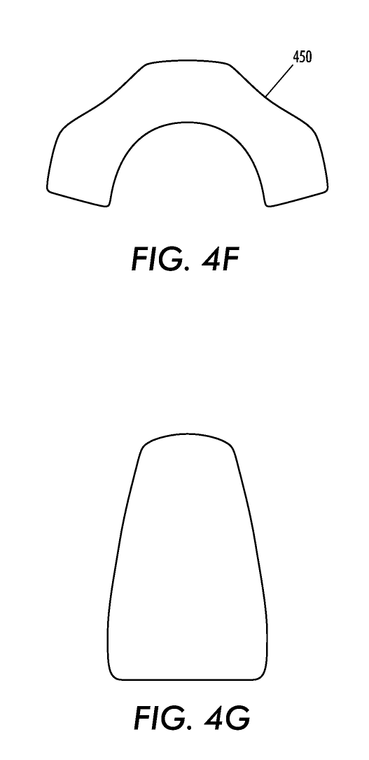

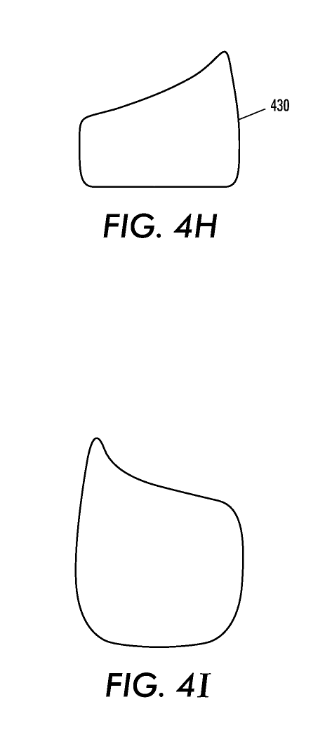

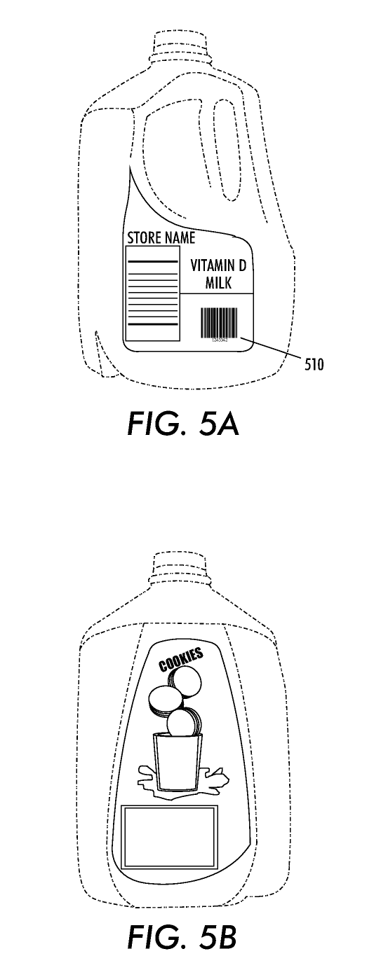

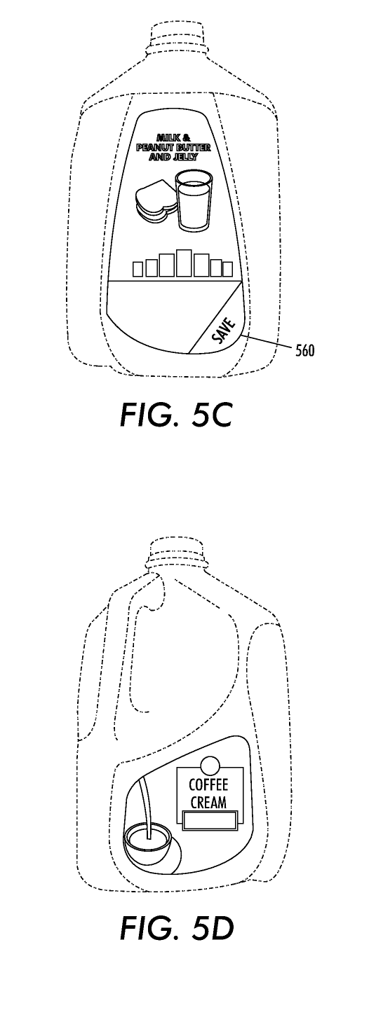

Once the advertiser has accepted or bid upon the available advertising space, or at least a portion thereof, the advertisers' ad copy is requested by the advertising interface. Preferably, the ad copy is provided in a format suitable to fit within a predefined shape (die cut) designed to fit on the side panel of a beverage container. For example, the shapes seen in FIGS. 4A-4I, illustrate some examples that work with containers as depicted in FIG. 3, 5A-5D and 6A-6D. The advertising interface sells, or brokers the sale, of advertising space and possibly design servoces to product manufacturers (e.g. Nabisco, Sara Lee, Pillsbury, Nestles, General Mills, Post, local grocer branded products such as cookies, cereal etc.). A larger product manufacturer would normally design their own advertisement. However, the advertising interface could also offer or broker the services of creative and advertising design for the local grocer branded products. The advertising space would be designed based upon the container size, gallon, half-gallon, quart, pint, and placement on the container. The advertisement could include tear off or bar code coupons (see 560 in FIG. 5C) as described below, where coupons could work at the register at the time of purchase, or on a return trip after the coupon is seen in the consumer's residence.

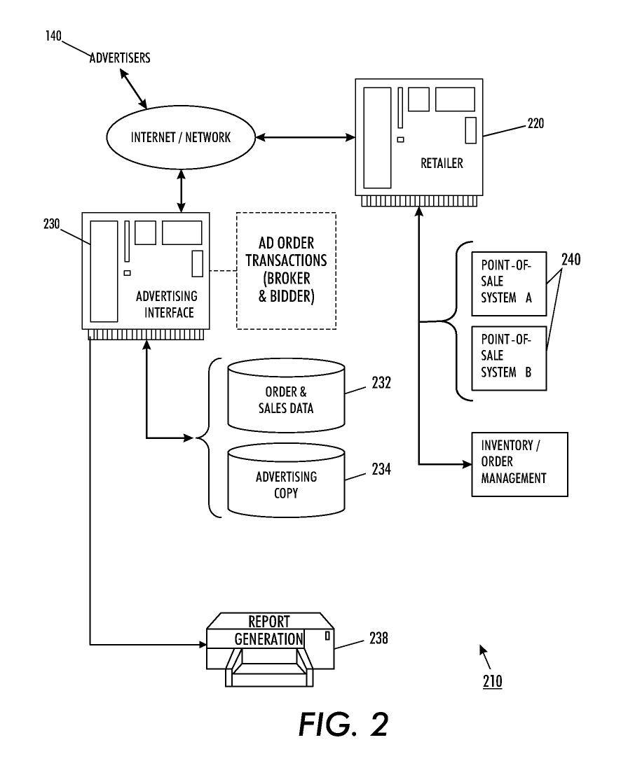

Upon receiving the advertising copy, the advertising interface handles preparing printed copy in the form of labels for affixing to beverage containers (e.g., die cut shapes as depicted in FIGS. 4A-4I). In one embodiment, the ad copy may be specified with respect to a particular shape in FIG. 4A-4I, or it is also contemplated that the advertising interface computer (230; FIG. 2) may work to automatically facilitate layout of the ad copy, possibly including the automated selection of a label size in which the ad copy is a best fit, or the communication of label shape/size data to the advertiser's computer to facilitate the advertiser's design of the ad copy. The present invention also contemplates an alternative including the automated programming and/or downloading of image information to a local or remote printing device in the event that such a device is used to print the ad copy—for example, copy printed on a deli or meat counter label machine and applied to packaging at the retail location.

In one embodiment, it is contemplated that a printing supplier will print the ad copy on appropriate label stock and that the label stock will be employed to apply labels directly to the containers in an automated fashion in much the same manner in which labels are presently employed, for example, a liner-fed labeling process. This portion of the process entails providing printed ad copy to the beverage bottler 130 for placement on the beverage containers. The printed labels in one or more of the shapes in FIGS. 4A-4I are then affixed to the containers (FIG. 3), are shipped to the retailer for sale to consumers 150 in various retail locations. As will described below, it may be that various portions of an order are shipped to different locations and that the ad copy labels appearing thereon are also different—based upon one or more factors that the advertiser has selected (e.g., increased advertising for low-selling goods in a particular geographic or other market segment).

The process is not yet complete, however, as an aspect of the method and system to be implemented may further include tracking and reporting of the completion of the advertisement placement (for confirmation of advertisement), along with determining any impact to sales of particular goods arising from the beverage container or product advertising. In particular, the advertising interface 120, or more specifically an automated computer system, tracks retailer data providing information relative to retailer sales. More specifically the system tracks sales of the beverage containers bearing the printed ad copy in conjunction with sales of at least one product advertised in the printed copy to identify and report the correlation between the beverage container advertising and changes in product sales volumes.

The present system contemplates at least two methods of confirming the association of advertising and increased purchases. In one embodiment, it is simply the increased purchase volume of advertised goods that is reported. In an alternative embodiment, the system contemplates an interface to the retailer point-of-sale system, whereby a bar code (510; FIG. 5A) or other identifying information on the beverage container can be employed to determine when an advertised product is purchased concurrently with a beverage container bearing the advertisement. Bar codes will be set up to automatically discount for coupons if that is the plan of the advertisement and the item is purchased at the same time; tear offs (e.g., 560; FIG. 5C) can also be used if grocer wants to track more purchases. In such an embodiment, where the ad copy on a beverage container includes a coupon, it is contemplated that the use of the coupon can be tracked by the point-of-sale system and again fed to the advertising interface and reported to the advertiser. In this last embodiment, therefore, a removable coupon forms a portion of the printed ad copy (e.g., where the removable portion is either torn away from the acopy or is peeled away in a multi-part printed label or ad copy).

The present method also contemplates the advertising interface 120 receiving, from the beverage bottler 130, data confirming the number of beverage containers with printed copy thereon delivered to the retailer and receiving, from the retailer 110, data confirming the number of beverage containers sold with printed copy thereon, and thereby also determining a number of any unsold beverage containers having printed copy thereon. The advertising interface can also generate a report to the advertiser including: (a) actual advertising volume printed, (b) advertising volume sold, and (c) advertised product volume sold for at least a particular time period (e.g., week, month, etc). And, the advertising interface may also adjust the fee or payment due from the advertiser as a function of the number of unsold beverage containers having printed copy thereon (e.g., if the milk reaches an expiration date, it's advertising “value” is lost). Alternatively, the advertising interface may automatically add or place additional ad copy for the advertiser in a subsequent beverage production for the retailer.

In accordance with the described process, it is contemplated that every market may be different as it relates to marketing geography/territory, (e.g., New England, Mid-Atlantic, Mid-west, West Coast, etc.) and grocery store size, (superstores, traditional grocers, and convenience stores). Similarly, the advertising interface may include the ability to track other promotional campaigns by the advertiser and/or retailer, and to determine whether other competitive campaigns will run at the same time.

The present invention contemplates the advertising interface receiving a commission based on the earnings of the milk sales. (e.g., $0.01 to $0.05 per container). It is also contemplated that the advertising interface could enter into a limited territorial exclusivity with a particular retailer for a period of time (e.g., regions or states that a retailer has operations in). The retail grocer receives compensation from the advertising interface (e.g., Ad-Milk) based upon the volume of business in milk, or whatever product(s) advertising is placed on.

In summary, the advertising interface 120 receives data indicating sales unit and dollar volume of advertised products from the grocer, permitting it to track sales increases for the advertised products and produce reports to the product manufacturer. The advertising interface 120 and the product manufacturer may also compare sales results to determine the effectiveness of a promotion or campaign.

The interface 120, in conjunction with the advertiser 140, also determines the base product purchases prior to the campaign. This is the measurement point for sales increase. For a campaign that runs for several weeks, e.g, four to eight weeks, the advertising interface receives order information (this would be in the form of duplicate order forms or a weekly report from a more automated system) and then prepares reports comparing order information/sales weekly to the base order and sales information. This information will have sufficient detail to report information by store location and/or store type (superstores, traditional stores and convenience stores). This level of reporting will allow for analysis of advertising effectiveness and future campaign targeting for the producer and grocer by store location and size. These reports would track information through the advertising campaign plus some follow-up period, for example, approximately four weeks. The additional time would be used to determine the residual effect of the advertising campaign.

Also illustrated in FIG. 1 is an indication of the various financial transactions that may occur in accordance with embodiments of the invention. For example, the advertising interface 120 receives a payment (e.g., per container) from the product manufacturer or advertiser 140. The retail grocer 110 receives a portion of the payment per container from the advertising interface 120 based upon container orders, or perhaps based upon actual sales.

Having generally described the operation of the method for the management of advertising on containers, attention is briefly turned to FIG. 2 where a simple block diagram depicts an embodiment of the system that may be employed for one or more aspects of the invention. It is anticipated that the present invention operates on a series of distributed computers that exchange data using one or more known formats for the transmission of information (e.g., XML data). The distributed system 210 includes a retailer computer 220 and an advertising interface or broker computer 230. The retail computer interfaces to point-of-sale systems in a plurality of retail locations, and includes an inventory and order tracking capability as is well known in retail grocery store management. The retailer's computer 220 automatically compiles, from a plurality of retail locations, orders for branded beverages being sold in containers having space for advertising thereon, and tracking the sales of such beverages, along with related of advertised products.

The advertising broker computer 230 receives, from the retailer computer 210 (via the Internet or similar network connection), beverage order data indicating a quantity of future beverage orders issued from said retailer to a bottler, wherein in response to the beverage order data, the advertising broker computer: (a) determines available advertising space associated with the beverage order, (b) automatically offers, to at least one advertiser, at least a portion of the available advertising space associated with the beverage order, (c) automatically receives, from an advertiser data indicating a request for advertising on at least a portion of the available advertising space, and (d) in response to the advertiser's acceptance, places an order for advertising copy in a format suitable to fit within a predefined shape (die cut). As illustrated, the advertising broker's computer also includes storage devices suitable for not only storing order and sales information as described above, but also for storing advertising copy and information relating to manufacturer's advertising.

As previously described, computer 230 further communicates with advertisers 140 (or their computers) and may operate software suitable for receiving advertising orders and/or managing the brokering or bidding for advertising space on the beverage containers. Such software may be similar to that used by eBay or similar on-line auction websites, and may include the automated exchange of data or other information via any of a number of “languages,” including hypertext markup language (HTML) and extensible markup language (XML). In one embodiment, the brokering or bidding operations may be carried out within a business-to-business transaction completed via the Internet or similar network. The advertising interface computer also tracks, with the retailer, sales of the beverage containers bearing the printed copy in conjunction with sales of at least one product indicated in the printed copy so as to determine a correlation between the beverage container advertising and any change in product sales volumes. As illustrated in FIG. 2, advertising copy, order and sales data, along with other pertinent information may be stored in memory (e.g., disks 232, 234, RAM or other media), in order to facilitate the various transactions described herein, as well as subsequent analysis and reporting of such information. Printer 238 is further intended to represent the report generation function associated with the advertising interface computer 230, and may include database functionality and software (e.g., Access, Sequel) that permit the analysis, formatting and output of reports that provide the information described.

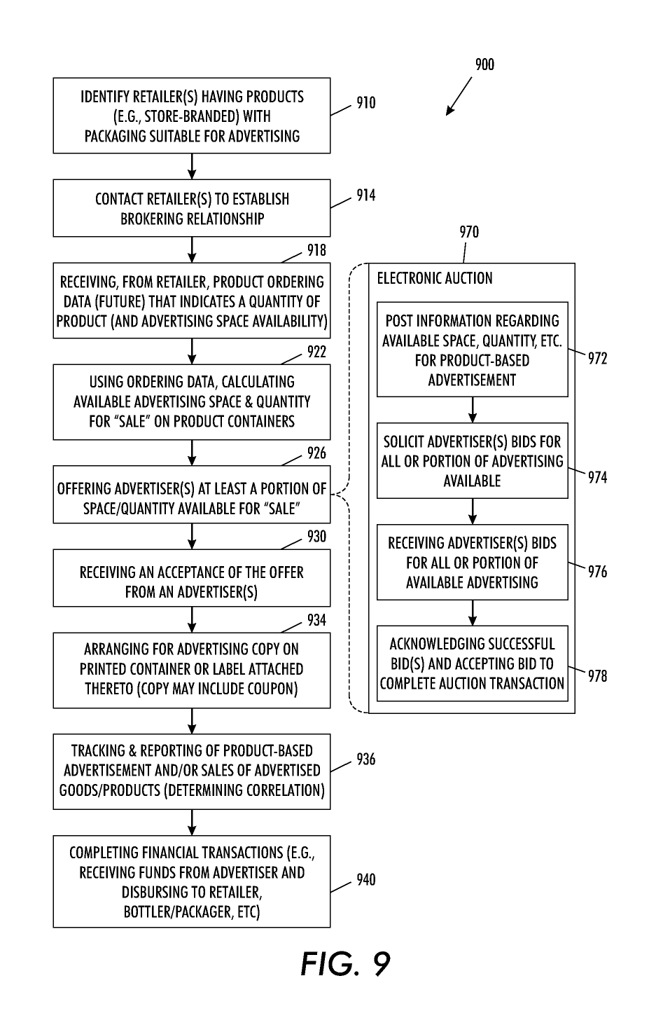

Turning next to FIG. 9, depicted therein is a flowchart illustrating the method generally described above, and more specifically exemplary method 900 for managing the sale of product advertising on disposable containers, for example milk cartons or jugs (e.g., polyethylene, HDPE, etc.). As illustrated, the method may start at 910 by identifying a retailer selling a branded product in a disposable container, where the container has a space or region suitable for placement of an advertisement. Once identified, the broker may then contact the retailer, 914, to establish a relationship whereby the broker represents the retailer and is able to provide to the retailer services that will promote the “sale” of advertising space on the retailer's packages. It will be recognized that aspects of this process, including the exchange of a brokerage agreement, may be accomplished using electronic media and networks so that it is not necessary for the parties to be physically present in the same location.

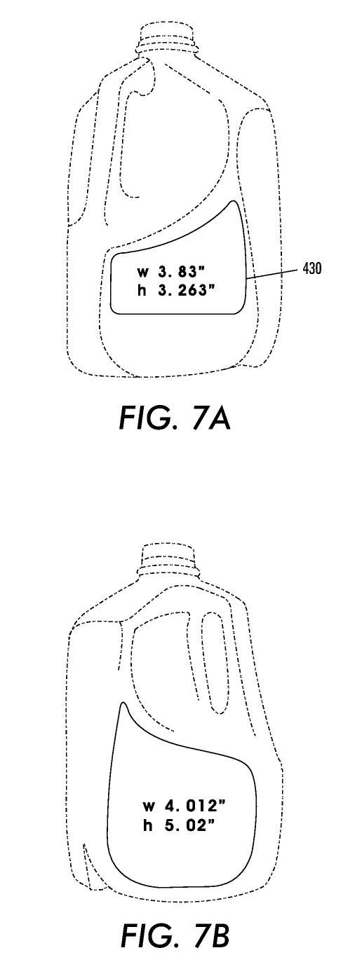

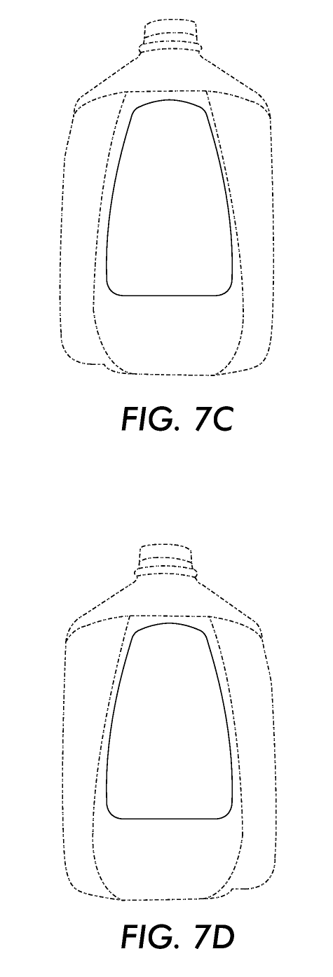

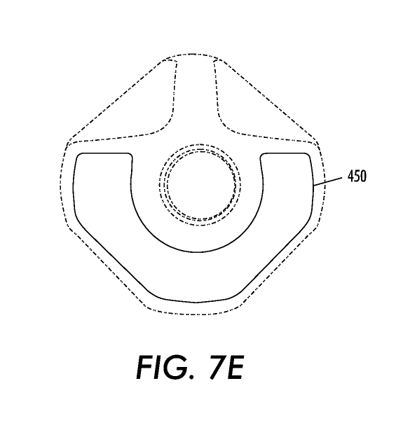

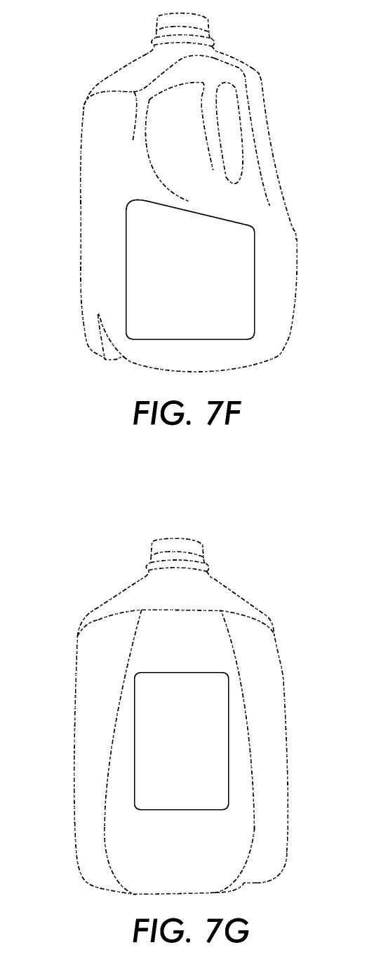

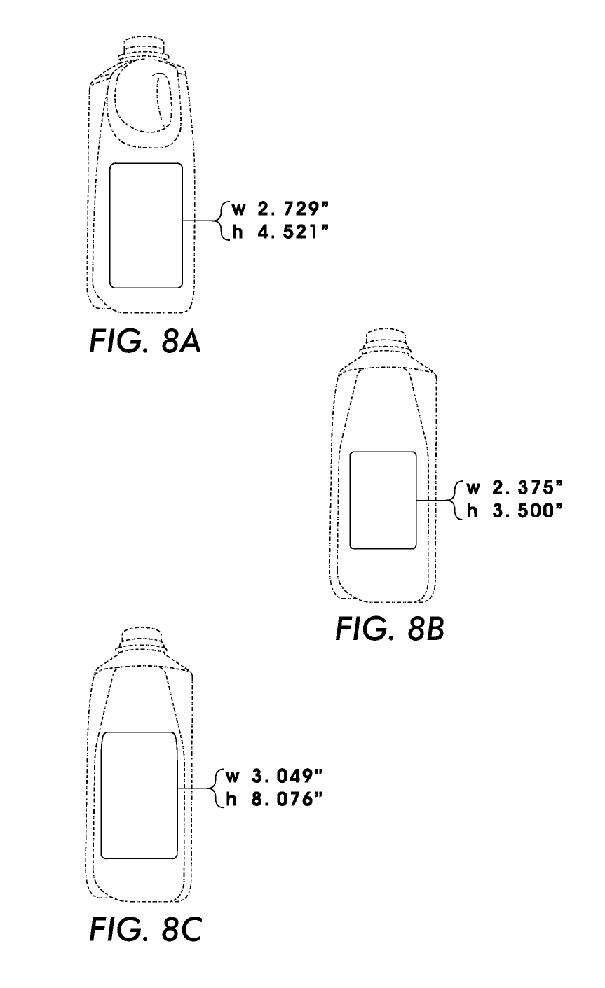

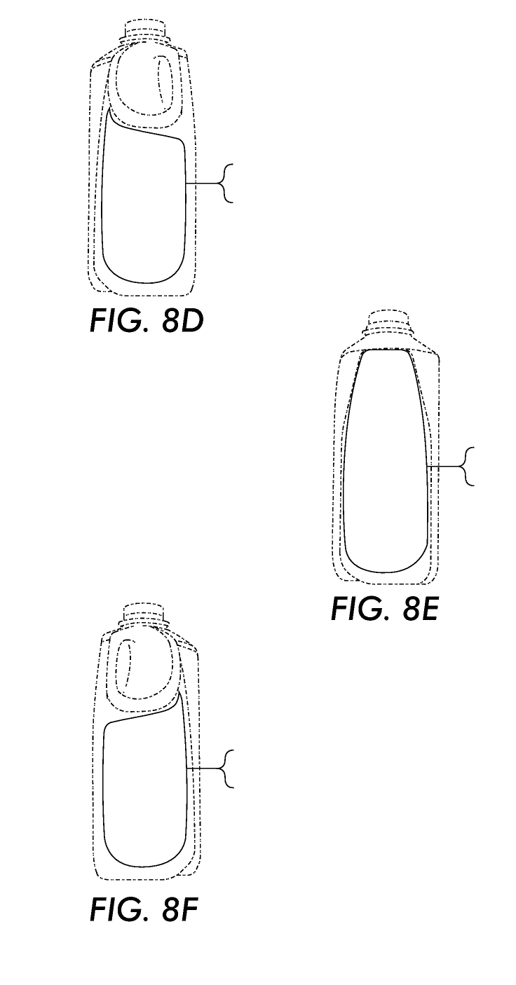

Once a relationship is established between the broker and the retailer, the broker receives, from the retailer, the retailer's product order data indicating projected quantity(ies) of product orders and/or orders issued from the retailer to a product supplier, 918. It may also be the case that the broker would have to receive information relative to the retailer's requirements and/or preferences relative to advertising. Such requirements may include limitations as to what may be advertised, or in what size or position the advertising may appear in. For example, the retailer may direct that advertising for another vendor's dairy products may not be placed on the retailer's branded milk containers. Using the milk jug example depicted in FIGS. 3-8F, the retailer and broker may determine whether entire side-panels (e.g., 410 in FIG. 4D), partial side-panels (e.g. 430 in FIG. 4H), or collars (e.g., 450 in FIG. 4F) are available for advertising.

Using the information provided by the retailer, the broker is then able to determine the advertising space and quantity associated with the product order—and available for “sale” for advertising placement as represented at 922. Once the available space and the estimated quantity is determined, the method contemplates automatically offering, to at least one advertiser, all or a portion of the advertising space and quantity available as depicted at 926. In other words, the broker determines if an advertiser(s) is interested in “buying” some available space on at least some product (e.g., a side panel on 50K milk containers that are on order for June 2005).

Although various offer-acceptance models may be employed, including those that are completed via the exchanges of documents and/or electronic communication, as depicted in block 970, the present invention also contemplates that the offer of advertising space may be completed via an electronic or on-line auction to solicit competitive bids on at least a portion of the available advertising space and quantity. Although an “eBay model” may be contemplated, where there is a “public” auction, it is also possible that the offer and bidding may be accomplished through networked communications with potential advertisers. An example of the interaction steps for an auction-like offering includes those set forth at 972-978, although it will be appreciated that alternative and/or additional steps may be implemented as well.

At 972, information is posted regarding available space, quantity, etc. for product-based advertisement. Advertisers are able to see the availability through a network, perhaps a subscription or registration based network. Another possibility is that the broker sends a broadcast fax, e-mail or similar transmission of information to prospective advertisers notifying them of the available space, quantities. The posting would also solicit advertiser(s) bids for all or portion of advertising available at 974. In response, advertisers would submit bids and the system would receive those bids for all or portion of available advertising at 976. Again, the process may be one where the bidding is “public” so other advertisers can see all the bids, or it may be a “private” process, where each advertiser submits their bid and is only able to determine if it was successful or unsuccessful after notification from the broker. At 978, successful bid(s) would be acknowledged and accepted to complete the auction transaction. Returning to 930, the offer of 926 is then automatically accepted for at least the portion of the available advertising space and quantity.

Although not specifically illustrated in FIG. 9, one embodiment of the method further contemplates the auction or offering of advertising to advertiser(s) based upon characteristics of the advertising. Such characteristics may include, but are not limited to, advertising quantity, advertising space per container, coupon availability, as well as advertising exclusivity (only advertisement on a branded product), and regional exclusivity (only advertiser on the products in a particular region or type of product (e.g. dairy)). It is believed that the auction will include the ability to adjust the bid price, perhaps on a per container basis, as a function of at least one of these characteristics.

Referring also to FIG. 1, once the advertising space has been sold, the broker works with the advertiser to receive the advertising copy and arrange for placement of the advertising copy in the portion of the advertising space available on product containers as depicted at 934. In some situations, the advertising may be pre-printed labels or coupons that are affixed to a product container. It is also contemplated, however, that the production or printing of the container may be modified so as to include the advertisement. It will also be appreciated that perishable or dated product (e.g., milk or dairy products) may have a shorter shelf life or other limitations that dictate the manner in which the advertising is applied to the product container.

The method, at 936, also indicates that the broker 120 (FIG. 1) tracks, with or via the retailer, sales of the product containers bearing the advertising copy. This permits a verification of advertising placement and also provides the advertiser with data as to the number of products bearing advertisements that are actually sold or distributed. The reporting by retailers may also include tracking, in conjunction with product sales, the sales of an advertised product(s) (i.e., those appearing in the advertising copy) so as to determine a correlation between the product container advertising and advertised product sales. In other words, determining the effectiveness of the advertising. One way of monitoring the impact of the advertising is to employ a removable coupon as at least a part of the advertising copy. Thus the removable coupon can be used to track purchases of advertised products. As an alternative, point-of-sale systems 240, perhaps including barcode or similar scanners and the like, may track the product advertising and/or coupon information and automatically record any purchases of goods that are advertised on the beverage containers.

In one embodiment of the method, the tracking/reporting operations may also include confirming the number of product containers with advertising copy thereon delivered to the retailer. Subsequently, the broker may receive, from the retailer, data confirming the number of product containers sold by the retailer. This data may be manually delivered or more preferably electronically communicated to the broker who then reports to the advertiser. Reports to the advertiser(s) may include actual advertising quantity printed, advertising quantity sold and advertised product volume sold by the retailer over a period of time (e.g., week, month, etc.).

Lastly, at 940, the broker may be responsible for completing the financial transaction(s) associated with the brokered advertising, including receiving funds from the advertiser and disbursing a portion of the funds to the retailer. It is further contemplated, as indicated in FIG. 1, that the broker may manage the acquisition of printed labels and works with the bottler or packager of the product to make sure the advertising is applied. Each of these steps may include some costs and the broker may operate to manage these actions, and to compensate the respective parties for those costs.

As noted above relative to the tracking and reporting operations, the advertisement “sale” may also be conditioned upon the number of products sold during a particular time period. In other words, while the advertiser may have contracted to have advertisements appear on 50K containers, if only 49K containers were sold, the others being returned due to expiration, damage, loss, etc., the advertiser would seek an adjustment of the advertising fees paid. Accordingly, the method 900 contemplates adjusting a fee due from the advertiser as a function of at least the number of product containers actually sold. It is also contemplated that the fee due from the advertiser may be adjusted as a function of at least the volume of advertised product sold by the retailer (e.g., sharing of “profit” resulting from the advertising impact).

It will be appreciated that various of the above-disclosed and other features and functions, or alternatives thereof, may be desirably combined into and with many other different systems or applications. Also, various presently unforeseen or unanticipated alternatives, modifications, variations or improvements therein may be subsequently made by those skilled in the art which are also intended to be encompassed by the following claims.

What is claimed is:

1. A method for managing the sale of advertising on beverage containers, comprising:
receiving, from a retailer, beverage order data indicating a quantity of future beverage orders issued from said retailer to a bottler;
in response to said beverage order data, determining available advertising space associated with the beverage order;
automatically offering, to at least one advertiser, at least a portion of the available advertising space associated with the beverage order;
automatically receiving, from the at least one advertiser, an acceptance of at least a portion of the available advertising space;
in response to the acceptance, requesting advertising copy in a format suitable to fit within a predefined shape;
upon receiving the advertising copy, preparing printed copy including the advertising;
affixing the printed copy to a plurality of beverage containers; and
tracking, with said retailer, sales of the beverage containers bearing the printed copy in conjunction with sales of at least one product indicated in the printed copy so as to determine a correlation between the beverage container advertising and any change in product sales volumes.

2. The method of claim 1, further comprising including a removable coupon as a portion of the printed copy.

3. The method of claim 2, further comprising tracking the use of the removable coupon for purchases of advertised products.

4. The method of claim 1, further comprising:
receiving data confirming the number of beverage containers with printed copy thereon delivered to the retailer;
receiving, from said retailer, data confirming the number of beverage containers with printed copy thereon sold by the retailer; and
reporting to the advertiser actual advertising volume printed, advertising volume sold and advertised product volume sold for at least one time period.

5. The method of claim 4, further comprising:
determining a number of unsold beverage containers having printed copy thereon; and
adjusting a fee due from the advertiser as a function of the number of unsold beverage containers having printed copy thereon.

6. The method of claim 1, wherein the steps of automatically offering available advertising space and automatically receiving an acceptance further comprise:
conducting an auction whereby an advertiser bids on at least one of the characteristics selected from the group consisting of: advertising quantity, advertising panels per beverage container, advertising exclusivity, and regional exclusivity; and
wherein the bid is adjusted as a function of at least one of the characteristics.

7. A distributed system for managing the sale of advertising on beverage containers, comprising:
a retailer computer for automatically compiling, from a plurality of retail locations, orders for beverages being sold in containers, said containers having space for advertising thereon, and tracking the sales of such beverages;
an advertising broker computer for receiving, from the retailer computer, beverage order data indicating a quantity of future beverage orders issued from said retailer, wherein in response to the beverage order data, the advertising broker computer (a) determines available advertising space associated with the beverage order, (b) automatically offers, to at least one advertiser, at least a portion of the available advertising space associated with the beverage order, (c) automatically receives, from an advertiser data indicating an acceptance for advertising offered on at least a portion of the available advertising space, and (d) in response to the advertiser's acceptance, places an order for advertising copy;
the advertising broker computer also tracking, with said retailer, sales of beverage containers bearing printed advertising copy in conjunction with sales of at least one product indicated in the advertising copy to determine a correlation between the beverage container advertising and product sales volumes.

8. The system of claim 7, wherein the advertising copy is produced in a panel form as a label suitable for application to the beverage container.

9. The system of claim 7, wherein said retailer computer and advertising broker computer are connected through a network connection to facilitate the exchange of information.

10. The system of claim 9, where said advertising broker computer further includes a memory to store information including sales of the beverage containers for subsequent analysis and reporting.

11. A method for managing the sale of product advertising on containers, comprising:
receiving, from a retailer, product order data indicating a quantity of future product orders issued from said retailer to a product supplier, said data identifying at least one characteristic of the container;
in response to said product order data, determining available advertising space and quantity associated with the product order based upon the container characteristic;
offering, to at least one advertiser, at least a portion of the advertising space and quantity available as a result of the product order;
receiving, from the at least one advertiser, an acceptance of at least the portion of the available advertising space and quantity; and
placing advertising copy in the portion of the advertising space and quantity available on product containers.

12. The method of claim 10, further comprising tracking, with said retailer, sales of the product containers bearing the advertising copy.

13. The method of claim 12, further comprising tracking, in conjunction with product sales, the sales of at least one advertised product appearing in the advertising copy so as to determine a correlation between the product container advertising and advertised product sales.

14. The method of claim 11, wherein the advertising copy includes a removable coupon, and where the method further comprises printing the removable coupon as at least a portion of the advertising copy.

15. The method of claim 14, further comprising tracking the use of the removable coupon for purchases of advertised products.

16. The method of claim 11, further comprising:
confirming the number of product containers with advertising copy thereon delivered to the retailer;
receiving, from said retailer, data confirming the number of product containers sold by the retailer; and
reporting to the advertiser actual advertising quantity printed, advertising quantity sold and advertised product volume sold by the retailer for at least one time period.

17. The method of claim 16, further comprising adjusting a fee due from the advertiser as a function of at least the number of product containers sold.

18. The method of claim 17, further comprising adjusting a fee due from the advertiser as a function of at least the volume of advertised product sold by the retailer.

19. The method of claim 18, further comprising determining a number of unsold containers having advertising copy thereon and reporting same to the advertiser.

20. The method of claim 11, wherein the steps of offering available advertising space and receiving an acceptance further comprise conducting an auction to solicit competitive bids on at least a portion of the available advertising space and quantity.

21. The method of claim 20,
wherein an advertising characteristic includes at least one characteristic selected from the group consisting of:
advertising quantity;
advertising space per container;
advertising exclusivity; and
regional exclusivity; and
where the auction adjusts the bid price per container as a function of at least one of the characteristics in the group.
